(19) United States
(12) Patent Application Publication
(10) Pub. No.: US 2026/0169327 A1
(43) Pub. Date: Jun. 18, 2026

(54) LIGHTING DEVICE

(71) Applicant: Japan Display Inc., Tokyo (JP)

(72) Inventors: Takeo KOITO, Tokyo (JP); Tae KUROKAWA, Tokyo (JP)

(21) Appl. No.: 19/532,339

(22) Filed: Feb. 6, 2026

Related U.S. Application Data
(63) Continuation of application No. PCT/JP2024/030478, filed on Aug. 27, 2024.

(30) Foreign Application Priority Data
Sep. 26, 2023 (JP) 2023-163089

(51) Int. Cl. G02F 1/1335; G02F 1/13357; G02F 1/1343

(52) U.S. Cl. CPC G02F 1/133528; G02F 1/133512; G02F 1/1336; G02F 1/134309

(57) ABSTRACT

The lighting device includes an optical element and a light-source device located under the optical element. The optical element includes a liquid crystal cell and a plurality of light-shielding films. The light-source device has a housing and a light source in the housing and is configured to apply light onto the optical element. The liquid crystal cell includes a substrate, a plurality of lower electrodes located over the substrate and arranged in a stripe form, a first orientation film over the plurality of lower electrodes, a liquid crystal layer over the first orientation film, a second orientation film over the liquid crystal layer, an upper electrode located over the second orientation film and overlapping the plurality of lower electrodes, a counter substrate over the upper electrode, and a first polarizing plate and a second polarizing plate respectively located under the substrate and over the counter substrate.

### CROSS-REFERENCE TO RELATED APPLICATIONS

This application is a Continuation of International Patent Application No. PCT/JP2024/030478, filed on Aug. 27, 2024, which claims the benefit of priority to Japanese Patent Application No. 2023-163089, filed on Sep. 26, 2023, the entire contents of which are incorporated herein by reference.

### FIELD

An embodiment of the present invention relates to a lighting device. For example, an embodiment of the present invention relates to a lighting device utilizing the orientation of a liquid crystal to control a light distribution.

### BACKGROUND

Lighting devices have been known which control the orientation of liquid crystals by controlling the voltage applied thereto and utilize the change in refractive index of the liquid crystal layer. For example, Japanese Patent Application Publication No. 2018-73661 discloses a lighting device having a light source and a dome-shaped liquid crystal portion covering the light source. In this lighting device, the light transmittance of the liquid crystal portion is controlled for each area by controlling the voltage applied to the liquid crystal portion, and as a result, the illuminated surface can be changed as desired.

### SUMMARY

An embodiment of the present invention is a lighting device. The lighting device includes an optical element and a light-source device located under the optical element. The optical element includes a liquid crystal cell and a plurality of light-shielding films. The light-source device has a housing and a light source in the housing and is configured to apply light onto the optical element. The liquid crystal cell includes a substrate, a plurality of lower electrodes located over the substrate and arranged in a stripe form, a first orientation film over the plurality of lower electrodes, a liquid crystal layer over the first orientation film, a second orientation film over the liquid crystal layer, an upper electrode located over the second orientation film and overlapping the plurality of lower electrodes, a counter substrate over the upper electrode, and a first polarizing plate and a second polarizing plate respectively located under the substrate and over the counter substrate. The plurality of light-shielding films is arranged in a stripe form and overlaps the plurality of lower electrodes. An extending direction of the plurality of lower electrodes is parallel to an extending direction of the plurality of light-shielding films.

An embodiment of the present invention is a lighting device. The lighting device includes an optical element and a light-source device located under the optical element. The optical element includes a liquid crystal cell and a plurality of light-shielding films. The light-source device has a housing and a light source in the housing and is configured to apply light onto the optical element. The liquid crystal cell includes a polarizing plate, a substrate over the polarizing plate, a plurality of lower electrodes located over the substrate and arranged in a stripe form, an orientation film over the plurality of lower electrodes, a liquid crystal layer over the orientation film, and a counter substrate over the liquid crystal layer. The plurality of light-shielding films is sandwiched by the polarizing plate and the substrate. An extending direction of the plurality of lower electrodes is parallel to an extending direction of the plurality of light-shielding films.

### BRIEF DESCRIPTION OF DRAWINGS

FIG. 1 is a schematic developed perspective view of a lighting device according to an embodiment of the present invention.

FIG. 2 is a schematic cross-sectional view of a lighting device according to an embodiment of the present invention.

FIG. 3A is a schematic developed perspective view of a part of a lighting device according to an embodiment of the present invention.

FIG. 3B is a schematic top view of lower electrodes of a lighting device according to an embodiment of the present invention.

FIG. 3C is a schematic top view of light-shielding films of a lighting device according to an embodiment of the present invention.

FIG. 4A is a schematic cross-sectional view for explaining an operation of a lighting device according to an embodiment of the present invention.

FIG. 4B is a schematic view for explaining an operation of a lighting device according to an embodiment of the present invention.

FIG. 5A is a schematic cross-sectional view for explaining an operation of a lighting device according to an embodiment of the present invention.

FIG. 5B is a schematic cross-sectional view for explaining an operation of a lighting device according to an embodiment of the present invention.

FIG. 5C is a schematic view of an illuminated surface for explaining an operation of a lighting device according to an embodiment of the present invention.

FIG. 6A is a schematic cross-sectional view of a lighting device according to an embodiment of the present invention.

FIG. 6B is a schematic cross-sectional view of a lighting device according to an embodiment of the present invention.

FIG. 6C is a schematic cross-sectional view of a lighting device according to an embodiment of the present invention.

FIG. 7A is a schematic cross-sectional view of a part of a lighting device according to an embodiment of the present invention.

FIG. 7B is a schematic cross-sectional view showing an arrangement of lower electrodes in a lighting device according to an embodiment of the present invention.

FIG. 7C is a schematic cross-sectional view showing an arrangement of lower electrodes in a lighting device according to an embodiment of the present invention.

FIG. 7D is a schematic cross-sectional view showing an arrangement of lower electrodes in a lighting device according to an embodiment of the present invention.

FIG. 8A is a schematic cross-sectional view of a part of a lighting device according to an embodiment of the present invention.

FIG. 8B is a schematic cross-sectional view of a part of a lighting device according to an embodiment of the present invention.

FIG. 9A is a schematic cross-sectional view of a lighting device according to an embodiment of the present invention.

FIG. 9B is a schematic developed perspective view of a part of a lighting device according to an embodiment of the present invention.

FIG. 10 is a schematic cross-sectional view for explaining an operation of a lighting device according to an embodiment of the present invention.

FIG. 11A is a schematic cross-sectional view for explaining an operation of a lighting device according to an embodiment of the present invention.

FIG. 11B is an illustrative timing chart of a lighting device according to an embodiment of the present invention.

FIG. 12A is a schematic view for explaining an operation of a lighting device according to an embodiment of the present invention.

FIG. 12B is a schematic view for explaining an operation of a lighting device according to an embodiment of the present invention.

FIG. 13 is an illustrative timing chart of a lighting device according to an embodiment of the present invention.

FIG. 14 is a schematic cross-sectional view for explaining an operation of a lighting device according to an embodiment of the present invention.

FIG. 15 is a schematic cross-sectional view for explaining an operation of a lighting device according to an embodiment of the present invention.

FIG. 16A is a schematic cross-sectional view of a lighting device according to an embodiment of the present invention.

FIG. 16B is a schematic cross-sectional view of a lighting device according to an embodiment of the present invention.

FIG. 16C is a schematic cross-sectional view of a lighting device according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate. The reference number is used when plural structures which are the same as or similar to each other are collectively represented, while a hyphen and a natural number are further used when these structures are independently represented.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

In the specification and claims, an expression that two structures are “orthogonal” or “perpendicular to each other” includes the states where the two structures intersect not only at 90° but also at an angle of 90°±10°. An expression that two structures are “parallel” includes a state where an angle between the extending directions of the two structures is 0°±10°.

### First Embodiment

In the present embodiment, a lighting device 100 according to an embodiment of the present invention is explained.

### 1. Structure of Lighting Device

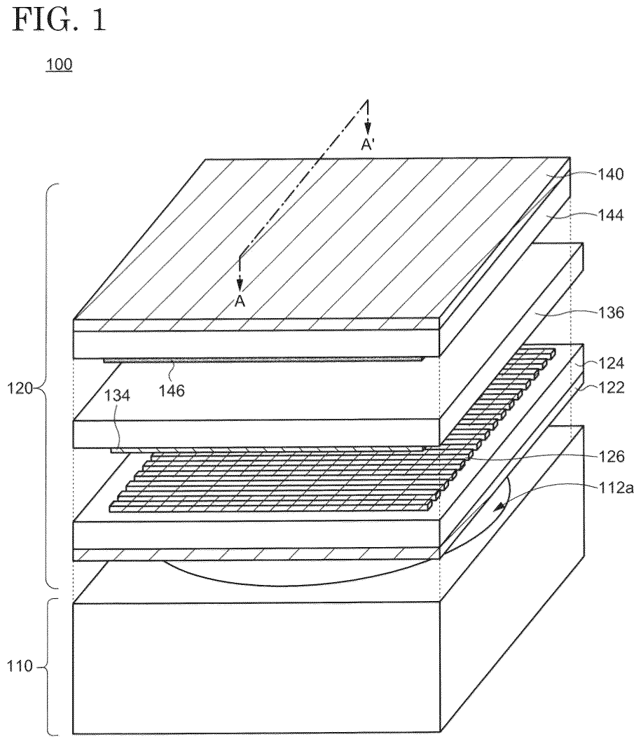

FIG. 1 is a schematic developed perspective view showing the overall structure of the lighting device 100. As shown in FIG. 1, the lighting device 100 has a light-source device 110 and an optical element 120 over the light-source device 110. As described below, the optical element 120 has a liquid crystal cell and a plurality of light-shielding films 146 as its fundamental components. Although the light-source device 110 and the optical element 120 are separated in FIG. 1, these components are fixed to each other by an adhesive or the like which is not illustrated. In addition, several components structuring the optical element 120 are omitted in FIG. 1 for visibility.

### 1-1. Light-Source Device

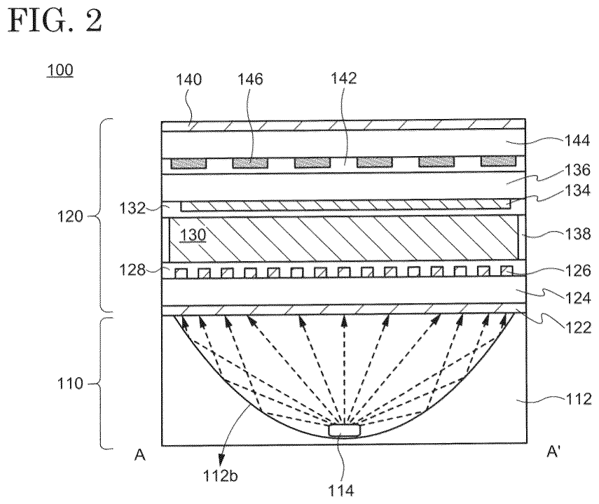

As shown in FIG. 2, which is a schematic view of a cross section along the chain line A-A′ in FIG. 1, the light-source device 110 has a housing 112 and a light source 114 arranged within the housing 112. The housing 112 supports the optical element 120 disposed thereover and is configured so that the light isotropically emitted from the light source 114 is applied onto almost the entire optical element 120. Hence, a recess 112a is formed in the housing 112 (see FIG. 1), and the light source 114 is disposed within this recess 112a. There are no restrictions on the material used to structure the housing 112, and the housing 112 may be composed of wood, a resin such as polypropylene and polylactic acid, glass, and a metal such as aluminum, copper, iron, and stainless steel, and the like. In order to efficiently utilize the light from the light source 114, the surface 112b of the recess 112a where the light source 114 is arranged is preferred to have high reflectivity for visible light. For this reason, when the housing 112 is composed of a material with low reflectance to visible light, such as wood, a resin, and glass, the surface 112b is preferred to be covered with a metal having high reflectance to visible light such as aluminum. This structure allows not only the light directly incident on the optical element 120 from the light source 114 but also the light incident on the optical element 120 after being reflected at the surface 112b to be used as illumination.

The light source 114 includes one or a plurality of light-emitting elements. As the light emitting element, an inorganic light-emitting diode (OLED) is exemplified. There is no restriction on the color of the light emitted from the light source 114. Thus, the light source 114 may be configured using one or a plurality of white-emissive light-emitting elements or may be configured to emit light of a variety of colors by combining red-, green-, and blue-emissive light-emitting elements. Since the light from the light source 114 isotropically travels, the light includes not only the components travelling from the light source 114 perpendicularly to the optical element 120 (in the normal direction of a substrate 124 described below) but also the components diagonally entering the optical element 120 (see dotted arrows in FIG. 2).

### 1-2. Optical Element

The optical element 120 is a component for transmitting the light from the light-source device 110 and controlling its travelling direction and spread. The use of the optical element 120 allows the light from the light-source device 110 to be processed to form an illuminated surface (a surface on which light illuminates an object) with an arbitrary shape and size. The optical element 120 includes a liquid crystal cell and a plurality of light-shielding films 146 as its fundamental components.

### (1) Liquid Crystal Cell

The liquid crystal has a substrate 124, a plurality of lower electrodes 126, a first orientation film 128, a liquid crystal layer 130, a second orientation film 132, an upper electrode 134, a counter substrate 136, a first polarizing plate 122, and a second polarizing plate 140 as fundamental components thereof.

The substrate 124 and the counter substrate 136 are components to transmit the light from the light-source device 110 and to provide mechanical strength to the liquid crystal cell. Therefore, both substrate 124 and counter substrate 136 are configured to transmit visible light and include glass or a resin such as a polyimide and a polycarbonate. The substrate 124 and the counter substrate 136 may be flexible. The substrate 124 is provided to cover the light-source device 110 and to close the recess 112a thereof.

The first polarizing plate 122 and the second polarizing plate 140 are disposed under the substrate 124 and over the counter substrate 136, respectively. The first polarizing plate 122 and the second polarizing plate 140 are arranged in the crossed-Nicols relationship so that their light transmission axes are orthogonal to each other.

As can be understood from FIG. 1 and FIG. 2, the plurality of lower electrodes 126 is arranged in a stripe form over the substrate 124. On the other hand, the upper electrode 134 facing the lower electrodes 126 is a single electrode and is disposed to overlap the plurality of lower electrodes 126. Although not illustrated, a protective insulating film may be provided between the plurality of lower electrodes 126 and the substrate 124 and/or between the counter substrate 136 and the upper electrode 134 to prevent impurities from entering from the substrate 124. The protective insulating film may be composed of one or a plurality of films containing a silicon-containing inorganic compound such as silicon oxide and silicon nitride, for example.

The lower electrodes 126 and the upper electrode 134 are each configured to transmit visible light. Hence, the lower electrodes 126 and the upper electrode 134 are composed of a conductive oxide having a light-transmitting property, such as indium-tin oxide (ITO) and indium-zinc oxide (IZO), for example. Although not illustrated, the plurality of lower electrodes 126 is connected to a driver circuit via wirings and is configured to be independently supplied with a potential. Therefore, it is possible to supply different potentials to two adjacent lower electrodes 126, for example. On the other hand, a constant potential (reference potential) is supplied to the upper electrode 134. Note that the potential supplied to the lower electrodes 126 and the upper electrode 134 may be a DC potential or a pulsed AC potential (e.g., a rectangular pulsed potential).

The first orientation film 128 and the second orientation film 132 are provided to cover the plurality of lower electrodes 126 and the upper electrode 134, respectively. The substrate 124 and the counter substrate 136 are secured to each other by a sealing material 138, and a liquid crystal layer 130 is sealed in the space formed by the sealing material 138, the first orientation film 128, and the second orientation film 132. The first orientation film 128 and the second orientation film 132 contain a resin such as a polyimide and are configured to orient liquid crystal molecules contained in the liquid crystal layer 130 in a certain direction. Hence, the first orientation film 128 and the second orientation film 132 are subjected to a rubbing process or are formed by utilizing a photo-alignment process. The directions in which the first orientation film 128 and the second orientation film 132 orient the liquid crystal molecules (the direction of the long axes of the liquid crystal molecules when they are oriented under the influence of the orientation films, which is hereinafter referred to as an orientation direction) are orthogonal to each other. That is, the first orientation film 128 and the second orientation film 132 are provided in the crossed-Nicols relationship with each other.

There are no restrictions on the structure of the liquid crystal molecules structuring the liquid crystal layer 130. Thus, the liquid crystal molecules may be nematic liquid crystals, smectic liquid crystals, cholesteric liquid crystals, or chiral smectic liquid crystals. The thickness of the liquid crystal layer 130 is appropriately adjusted within a range equal to or greater than 2 μm and equal to or less than 5 μm, for example. An electric field (vertical electric field) of sufficient strength can be formed in the liquid crystal layer 130 by selecting the thickness in this range. Although not illustrated, spherical or columnar spacers may be placed in the liquid crystal layer 130 to maintain the distance between the first orientation film 128 and the second orientation film 132 (i.e., the thickness of the liquid crystal layer 130) constant.

There are also no restrictions on the operating mode of the liquid crystal cell described above, and either TN mode or VA mode may be applied.

### (2) Light-Shielding Film

The plurality of light-shielding films 146 is configured not to transmit light so as to block part of the light from the light-source device 110. Preferably, the plurality of light-shielding films 146 is configured to have a low absorbance and a high reflectance for the light from the light-source device 110. Such a feature allows the light from the light-source device 110 to be reflected within the liquid crystal cell and the housing 112 and to be extracted to the outside, which contributes to efficient use of the light from the light source 114 and suppresses heat generation due to light absorption. Therefore, it is preferable to configure the plurality of light-shielding films 146 to include a metal such as aluminum, silver, molybdenum, titanium, and tantalum. Note that a resin in which black pigment is dispersed may also be used, although the efficiency of the light utilization may be reduced.

In the lighting device 100, the plurality of light-shielding films 146 is formed over a support substrate 144 (under the support substrate 144 in FIG. 2), and the support substrate 144 is fixed to the counter substrate 136 by an adhesive layer 142 as shown in FIG. 1 and FIG. 2. On the other hand, the second polarizing plate 140 is provided over the support substrate 144. Accordingly, the plurality of light-shielding films 146 is disposed between the counter substrate 136 and the second polarizing plate 140 in the lighting device 100.

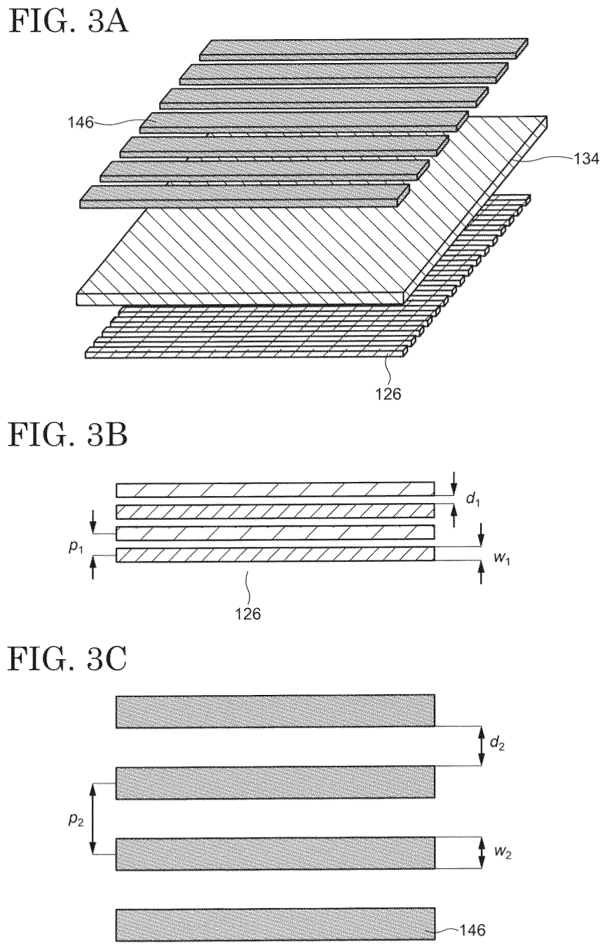

FIG. 3A shows a schematic perspective view showing the arrangement of the plurality of lower electrodes 126, the upper electrode 134, and the plurality of light-shielding films 146. As can be understood from FIG. 3A, the plurality of light-shielding films 146 is also arranged in a stripe form similar to the plurality of lower electrodes 126. The extending direction of the plurality of light-shielding films 146 is parallel to that of the plurality of lower electrodes 126. However, the width, the spacing, and the pitch are different between the lower electrodes 126 and the light-shielding films 146. Specifically, as schematically shown in FIG. 3B and FIG. 3C, the width w₁ of the plurality of lower electrodes 126 is smaller than the width w₂ of the plurality of light-shielding films 146. For example, the width w₁ is equal to or greater than 2 μm and equal to or less than 1.5 mm, while the width w₂ is equal to or greater than 95 μm and equal to or less than 50 mm. The spacing d₁ between adjacent lower electrodes 126 is smaller than the spacing d₂ between adjacent light-shielding films 146. For example, the spacing d₁ is equal to or greater than 3 μm and equal to or less than 10 μm, while the spacing d₂ is equal to or greater than 5 μm and equal to or less than 5 mm. Thus, the pitch p₁ of the plurality of lower electrodes 126 is also smaller than the pitch p₂ of the plurality of light-shielding films 146, where the former is equal to or greater than 5 μm and equal to or less than 1.5 mm and the latter is equal to or greater than 100 μm and equal to or less than 60 mm, for example.

### 2. Control of Illuminated Surface by Lighting Device

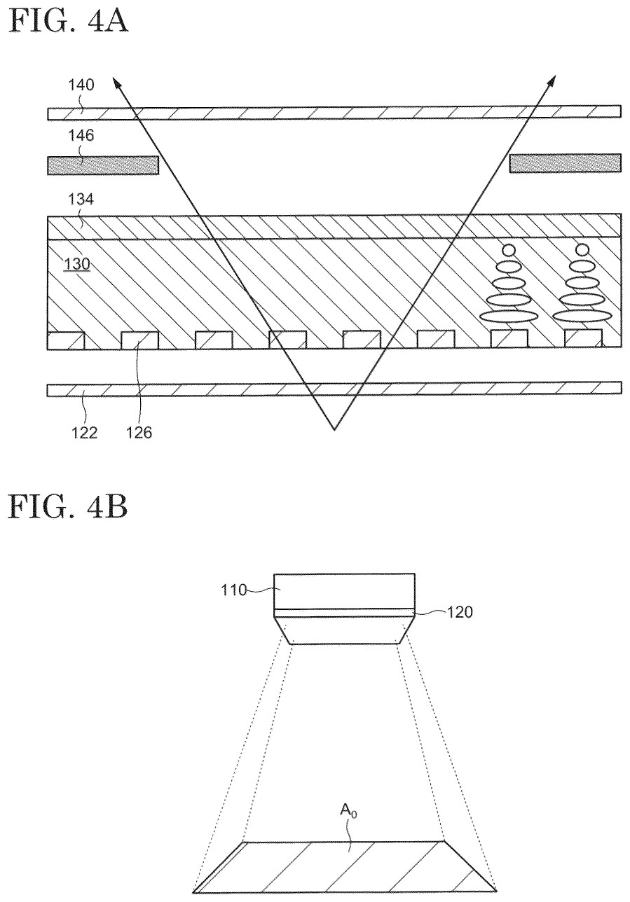

Hereinafter, the control of the illuminated surface using the lighting device 100 is described. As described above, the first orientation film 128 and the second orientation film 132 are provided in the crossed-Nicols relationship with each other. Thus, in the case where the liquid crystal cell is driven according to the TN mode, for example, the linearly polarized light passing through the first polarizing plate 122 among the light from the light-source device 110 is optically rotated 90° when passing through the liquid crystal layer 130 in the absence of an electric field in the liquid crystal layer 130, and its polarization axis becomes parallel to the light-transmission axis of the second polarizing plate 140. Therefore, this linearly polarized light passes through the second polarizing plate 140 (see the arrows in FIG. 4A). At this time, part of the linearly polarized light is blocked by the light-shielding film 146. However, since the light from the light source 114 is not collimated light but travels almost isotropically to enter the optical element 120, the light passing between the adjacent light-shielding films 146 is also diffused. As a result, it is possible to provide an illuminated surface A₀ with an almost uniform illuminance distribution, which is not influenced by the arrangement of the light-shielding films 146 and reflects the shape of the lighting device 100 as shown in FIG. 4B, although depending on the width w₂ and the spacing d₂ of the light-shielding films 146 and the distance between the lighting device 100 and the illuminated surface.

On the other hand, the liquid crystal molecules raise up when a vertical electric field is generated in the liquid crystal layer 130 by applying a potential difference between all of the lower electrodes 126 and the upper electrode 134, although not illustrated. Therefore, the linearly polarized light passing through the first polarizing plate 122 does not optically rotate within the liquid crystal layer 130 and maintains its polarization axis orthogonal to the light-transmission axis of the second polarizing plate 140. Therefore, the light from the light-source device 110 is shielded by the second polarizing plate 140 and does not provide an illuminated surface.

Thus, the liquid crystal layer 130 functions as a light switch which is capable of realizing a state in which light is transmitted (on) and a state in which light is not transmitted (off). Cooperation of the plurality of light-shielding films 146 with the light-switch function of the liquid crystal layer 130 makes it possible to process the light from the light-source device 110 to create illuminated surfaces having a variety of shapes and sizes.

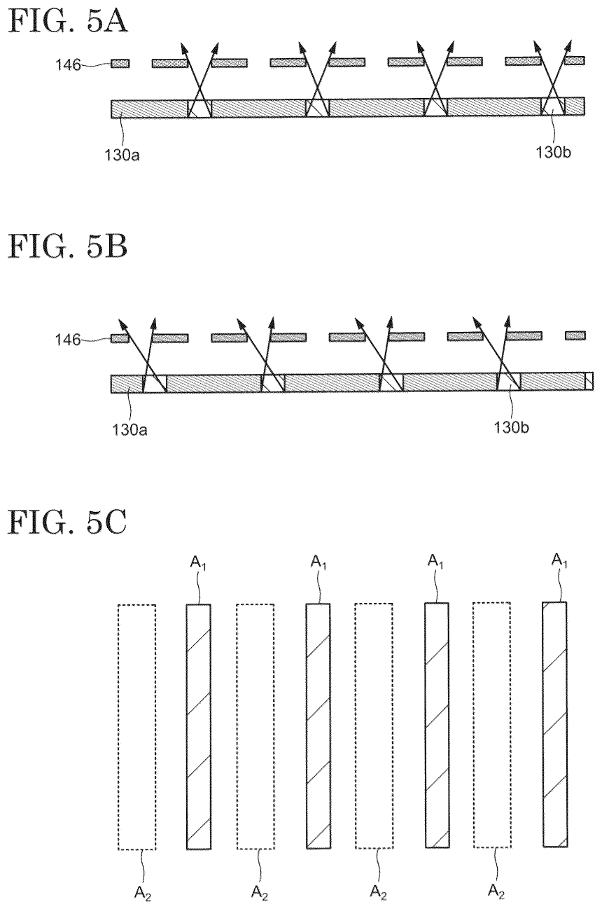

For example, a vertical electric field is generated between the upper electrode 134 and a part of the lower electrodes 126 as shown in FIG. 5A. In the example shown in FIG. 5A, the liquid crystal cell is driven so that the vertical electric field is generated in portions 130a of the liquid crystal layer 130 while no vertical electric field is generated in the other portions 130b. When the liquid crystal cell is driven in this way, the portions 130b where no vertical electric field exists act as slits. In other words, a plurality of virtual light sources having a stripe shape can be apparently created under the light-shielding films 146. As a result, elongated illuminated surfaces A₁ parallel to the extending direction of the lower electrodes 126 can be created by the light travelling from the stripe-shaped virtual light sources and passing through the light-shielding films 146 (FIG. 5C). The number and the width of illuminated surfaces A₁ can be controlled by appropriately selecting the lower electrodes 126 for generating the vertical electric field and adjusting their potentials. The plurality of light-shielding films 146 also functions as slits to block a part of the light from these stripe-shaped light sources.

Furthermore, the illuminated surfaces can also be shifted (see the illuminated surfaces A₂ in FIG. 5C) by shifting the portions 130b, in which the vertical electric field is generated, in a direction perpendicular to the extending direction of the lower electrodes 126 (FIG. 5B). That is, it is possible to form an arbitrary number of virtual light sources in a stripe shape having an arbitrary width and to change the position of the stripe-shaped light sources relative to the plurality of light-shielding films 146 functioning as fixed slits by using the liquid crystal cell. Accordingly, the travelling direction of the light emitted from the virtual light sources can be changed. In summary, an arbitrary number of illuminated surfaces with a variety of shapes and sizes (widths) can be created and their positions can also be changed by the lighting device 100.

### 3. Modified Examples

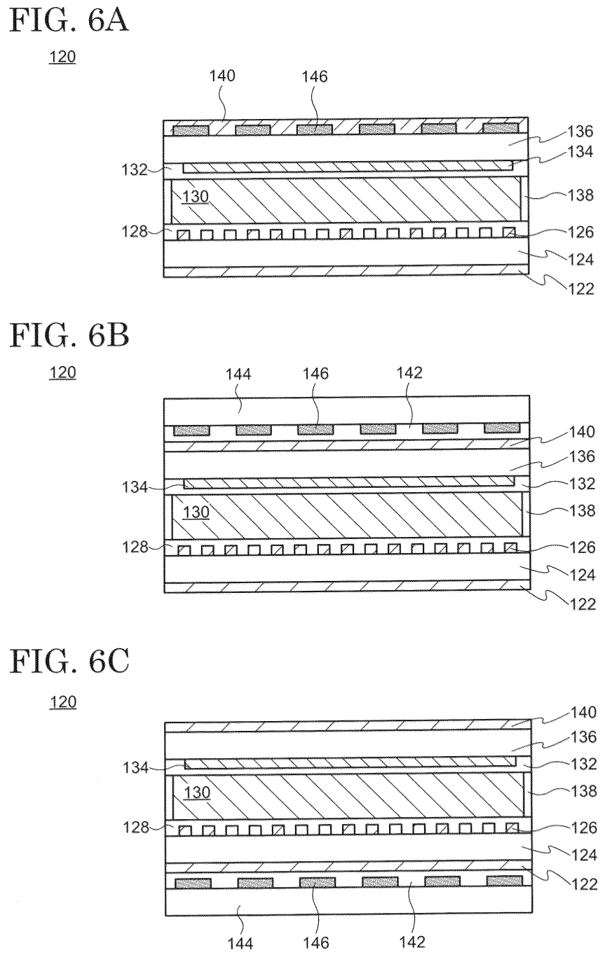

The structure of the lighting device 100 is not limited to the structure described above, and a variety of modifications can be carried out. For example, the light-shielding films 146 may be formed over the counter substrate 136 so as to be in contact with the counter substrate 136 and the second polarizing plate 140 as shown in FIG. 6A. In this case, the light-shielding films 146 may be formed over the counter substrate 136 using an ink-jet method, a sputtering method, or a chemical vapor deposition (CVD) method, or the like before the liquid crystal layer 130 is injected or before the counter substrate 136 and the substrate 124 are fixed, for example. In this case, since the light-shielding films 146 can be formed using alignment marks prepared on the counter substrate 136 and/or the substrate 124, the alignment accuracy thereof can be improved.

Alternatively, the light-shielding films 146 may be arranged over the second polarizing plate 140 as shown in FIG. 6B. In this case, the second polarizing plate 140 may be provided over the counter substrate 136, and the support substrate 144 over which the light-shielding films 146 are provided may be bonded to the second polarizing plate 140 using the adhesive layer 142. Since most of the light from the outside can be blocked by the light-shielding films 146 in such a structure, light degradation of the second polarizing plate 140 as well as other components forming the liquid crystal cell can be suppressed.

Alternatively, the light-shielding films 146 may be arranged under the liquid crystal cell, i.e., under the first polarizing plate 122 as shown in FIG. 6C. In this case, the first polarizing plate 122 may be provided to the substrate 124, and the support substrate 144 over which the light-shielding films 146 are provided may be bonded to the first polarizing plate 122 using the adhesive layer 142, similar to the example shown in FIG. 6B. In this structure, since most of the light from the light source 114 can be blocked by the light-shielding films 146, it is possible to suppress heat generation and deterioration caused by light absorption of the first polarizing plate 122. Note that, in this structure, a plurality of stripe-shaped virtual light sources with fixed widths are apparently formed by the light-shielding films 146, and slits with variable widths, numbers, and positions are configured thereover by the liquid crystal cell. Therefore, the effects described above can be obtained in the same way.

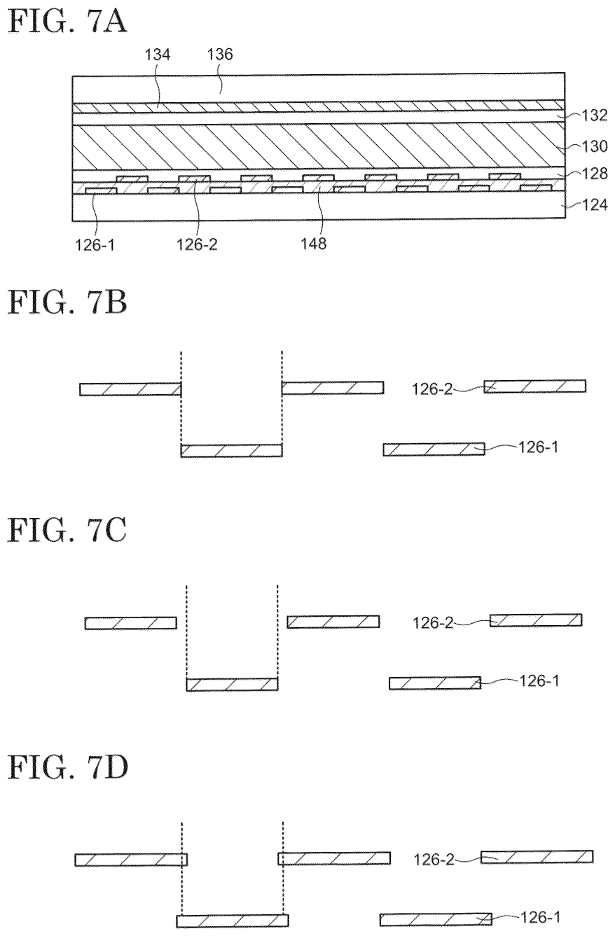

As described above, the stripe-shaped virtual light sources are formed using the vertical electric field generated in the liquid crystal layer 130 in the lighting device 100. Therefore, when the distance d₁ between adjacent lower electrodes 126 increases, light leakage occurs because the vertical electric field cannot be sufficiently formed in the liquid crystal layer 130 between adjacent lower electrodes 126. However, there is a limit to the reduction of the distance d₁ due to process constraints. Therefore, the apparent distance between adjacent lower electrodes 126 may be reduced by arranging the lower electrodes 126 in two layers. Specifically, the plurality of lower electrodes 126 is alternately arranged in different layers as shown in FIG. 7A. That is, among the lower electrodes 126 arranged in a stripe shape, the odd-numbered lower electrodes 126-1 are placed in a lower layer on the substrate 124 side, while the even-numbered lower electrodes 126-2 are placed in an upper layer on the liquid crystal layer 130 side. An interlayer insulating film 148 containing a silicon-containing inorganic compound such as silicon nitride and silicon oxide or a polymer such as an epoxy resin and an acrylic resin may be arranged between the upper layer and the lower layer to prevent conduction between the lower electrodes 126 placed in the upper layer and the lower layer. Employment of such an arrangement apparently allows the distance between adjacent lower electrodes 126-1 and 126-2 to be reduced to 0 μm as shown in FIG. 7B. Note that the lower electrodes 126-1 and 126-2 arranged in the upper layer and the lower layer may not overlap in the vertical direction (normal direction of the substrate 124) (FIG. 7C) or may partially overlap (FIG. 7D).

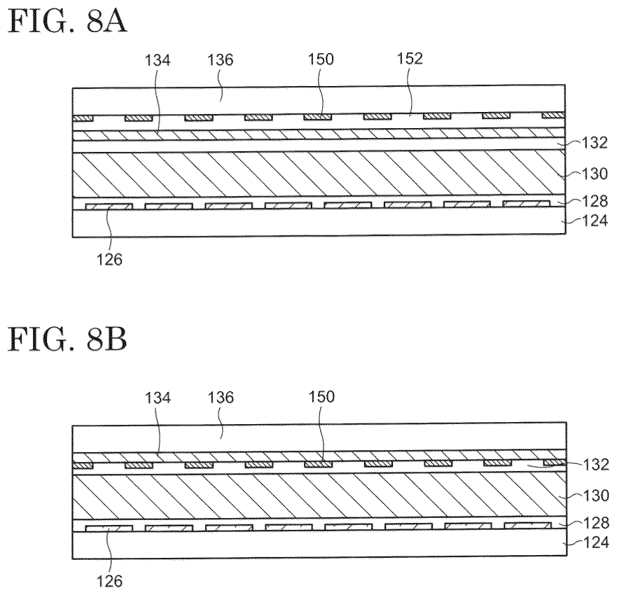

Alternatively, auxiliary light-shielding films 150 may be arranged over the liquid crystal layer 130 to prevent light leakage as shown in FIG. 8A. The auxiliary light-shielding films 150 may be formed using the material which can be used for the light-shielding films 146. The auxiliary light-shielding films 150 are arranged in a stripe shape so as to overlap the region between adjacent lower electrodes 126 in the vertical direction. The auxiliary light-shielding films 150 may be provided between the counter substrate 136 and the upper electrode 134 or between the upper electrode 134 and the liquid crystal layer 130 as shown in FIG. 8B. In the former case, an overcoat 152 covering the auxiliary light-shielding films 150 may be further provided, or the auxiliary light-shielding films 150 may be provided so as to be in contact with the upper electrode 134. In addition, an insulating film which is not illustrated may also be provided between the auxiliary light-shielding films 150 and the counter substrate 136. In the latter case, the auxiliary light-shielding films 150 and the upper electrode 134 may be in contact with each other, or an insulating film which is not illustrated may be provided therebetween.

### Second Embodiment

In the present embodiment, a lighting device 160 having a different structure from the lighting device 100 described in the First Embodiment is explained. The structures the same as or similar to those described in the First Embodiment may be omitted.

### 1. Structure of Liquid Crystal Cell

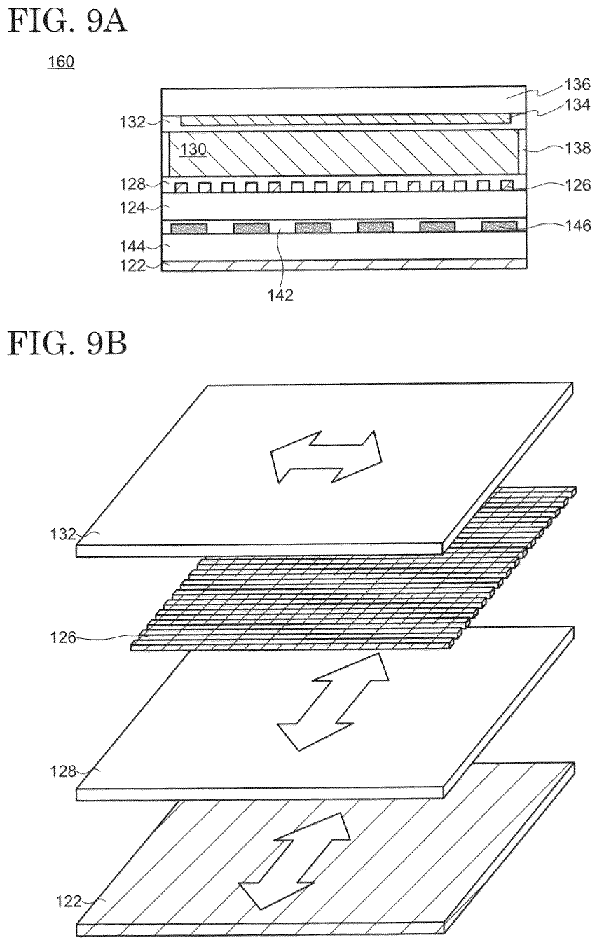

A difference of the lighting device 160 from the lighting device 100 is the structure of the liquid crystal cell. Specifically, similar to the lighting device 100, the lighting device 160 provided over the light-source device 110 has the liquid crystal cell and the plurality of light-shielding films 146 as shown in FIG. 9A. However, the total number of polarizing plates in the lighting device 160 is one, and the first polarizing plate 122 is located between the light-source device 110 and the liquid crystal layer 130. Furthermore, the liquid crystal layer 130 does not function as a light switch but serves as a lenticular lens. Hence, the liquid crystal cell is configured so that the contribution of the transverse electric field generated between adjacent lower electrodes 126 is larger than that of the vertical electric field in the liquid crystal layer 130. More specifically, the thickness of the liquid crystal layer 130 is increased to form the liquid crystal layer 130 with a thickness equal to or greater than 10 μm and equal to or less than 100 μm, for example. Not only can a large vertical electric field be formed, but also the high light transmittance of the liquid crystal layer 130 can be maintained by selecting the thickness in this range.

For this purpose, the first polarizing plate 122 is arranged under the support substrate 144, and the plurality of light-shielding films 146 is disposed over the support substrate 144 in the lighting device 160. The support substrate 144 and the substrate 124 are secured to each other by the adhesive layer 142 or the like. No polarizing plate is provided over the counter substrate 136. Note that, although not illustrated, the plurality of light-shielding films 146 may be provided under the support substrate 144 to be in contact with the support substrate 144 similar to the lighting device 100.

As shown in FIG. 9B, the first polarizing plate 122 is provided so that the light-transmission axis thereof is perpendicular to the extending direction of the plurality of lower electrodes 126. The first orientation film 128 is also provided so that the orientation direction thereof is perpendicular to the extending direction of the plurality of lower electrodes 126. The first orientation film 128 and the second orientation film 132 are in the crossed-Nicols relationship with each other.

### 2. Control of Illuminated Surface by Lighting Device

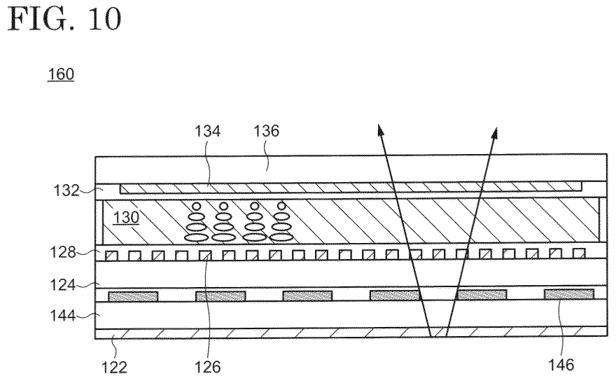

When no electric field is generated in the liquid crystal layer 130, i.e., no potential is given to the lower electrodes 126 and the upper electrode 134, or the same potential is given to all of the lower electrodes 126 and the upper electrode 134, the liquid crystal molecules are oriented according to the orientation directions of the first orientation film 128 and the second orientation film 132. Therefore, the liquid crystal molecules are oriented according to the orientation direction of the first orientation film 128 on the side of the first orientation film 128 and rotate in a plane as they approach the second orientation film 132. The orientation direction on the first orientation film 128 side and that on the second orientation film 132 side are orthogonal. Therefore, linearly polarized light passing through the first orientation film 128 is optically rotated 90° when passing through the liquid crystal layer 130 as shown in FIG. 10. Since no polarizing plate is provided above the liquid crystal layer 130 in the lighting device 160, the optically rotated linearly polarized light passes through the upper electrode 134 and the counter substrate 136 and is extracted to the outside (see the arrows in the drawing).

Here, the plurality of light-shielding films 146 arranged in a stripe form functions as slits partially blocking the light similar to the First Embodiment. However, since the light from the light source 114 isotropically travels as described above, the light passing between the light-shielding films 146 spreads when passing through the liquid crystal layer 130 and the like, although depending on the distance from the lighting device 160 and the pitch and width of the light-shielding films 146. Therefore, when the liquid crystal cell is not driven, an illuminated surface with nearly uniform illuminance can be provided.

Next, the case is explained in which the liquid crystal cell is driven to cause the liquid crystal layer 130 to function as a lenticular lens. In the lighting device 160, the potential supplied to the plurality of lower electrodes 126 is periodically varied to form a transverse electric field, by which a refractive index distribution is formed in the liquid crystal layer 130 to result in a plurality of semi-cylindrical liquid crystal lenses extending in the extending direction of the lower electrodes 126. Therefore, the entire liquid crystal layer 130 functions as a lenticular lens.

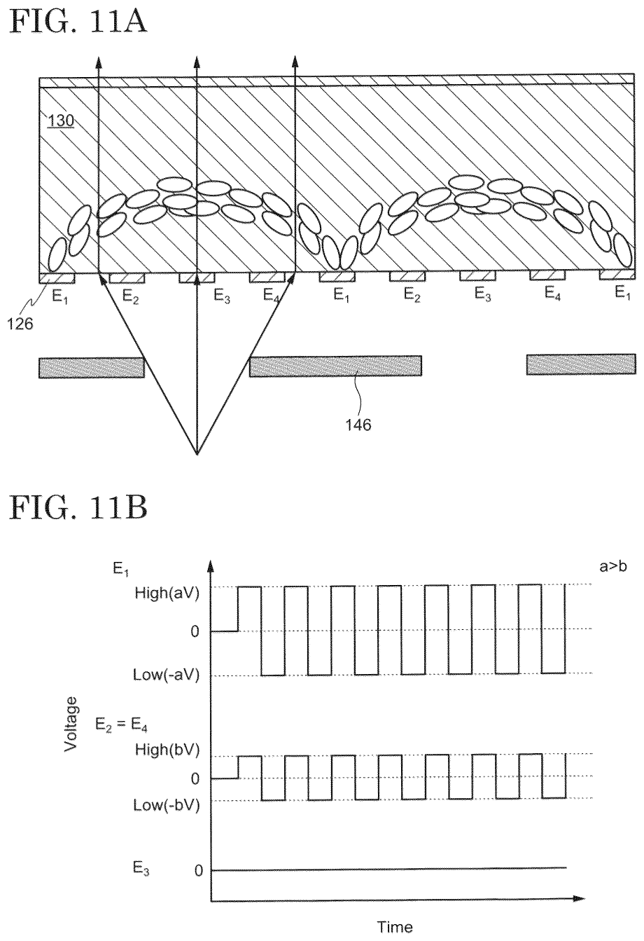

As an example, the liquid crystal cell is driven so that the four consecutive lower electrodes 126 (electrodes E₁ to E₄) are treated as one unit and the potential applied thereto is periodically changed as shown in FIG. 11A and FIG. 11B. Here, according to the timing chart in FIG. 11B, the potentials applied to the electrodes E₁, E₂, and E₃ are decreased in this order, and then the potentials of the electrodes E₃, E₄, and E₁ are increased in this order. That is, the highest pulsed AC potential (±aV) is applied to the electrode E₁, a medium pulsed AC potential (±bV, a>b) is applied to the electrodes E₂ and E₄ adjacent to the electrode E₁, and the lowest potential (e.g., reference potential (0 V)) is applied to the electrode E₃ located between the electrodes E₂ and E₄. When a transverse electric field is generated between the lower electrodes 126 by driving the liquid crystal cell in this manner, the rising angle (tilt angle) of the liquid crystal molecules also periodically changes. The tilt angle is maximum over the electrode applied with the largest potential (in this case, the electrode E₁). The tilt angle is the smallest over the electrode applied with the smallest potential (in this case, the electrode E₃), and the orientation direction of the liquid crystal molecules is substantially the same as the orientation direction of the first orientation film 128. The tilt angles of the liquid crystal molecules over the electrodes E₂ and E₄ are between these tilt angles (see ellipses in FIG. 11A). This orientation of the liquid crystal molecules results in the periodic formation of a semi-circular arc-shaped refractive index distribution on the lower electrode 126 side of the liquid crystal layer 130. As a result, a plurality of semi-cylindrical liquid crystal lenses are formed in the liquid crystal layer 130, which allows the liquid crystal layer 130 to function as a lenticular lens for the light components parallel to the direction of the refractive index distribution.

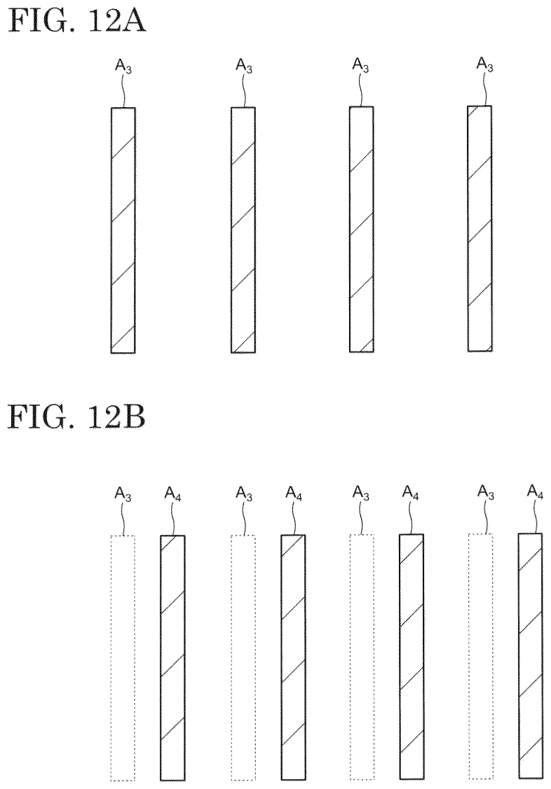

Since the light-transmission axis of the first polarizing plate 122 is perpendicular to the extending direction of the lower electrodes 126 as described above, it coincides with the direction of the refractive index distribution. Thus, the linearly polarized light passing through the first polarizing plate 122 and passing between the adjacent light-shielding films 146 is affected by the refractive index distribution of the liquid crystal layer 130. Hence, for example, the linearly polarized light passing between the light-shielding films 146 can be focused by appropriately adjusting the potential supplied to the lower electrodes 126 to form the refractive index distribution covering the space between adjacent light-shielding films 146 as shown in FIG. 11A. As a result, an elongated illuminated surface A₃ parallel to the extending direction of the lower electrodes 126 can be provided as shown in FIG. 12A.

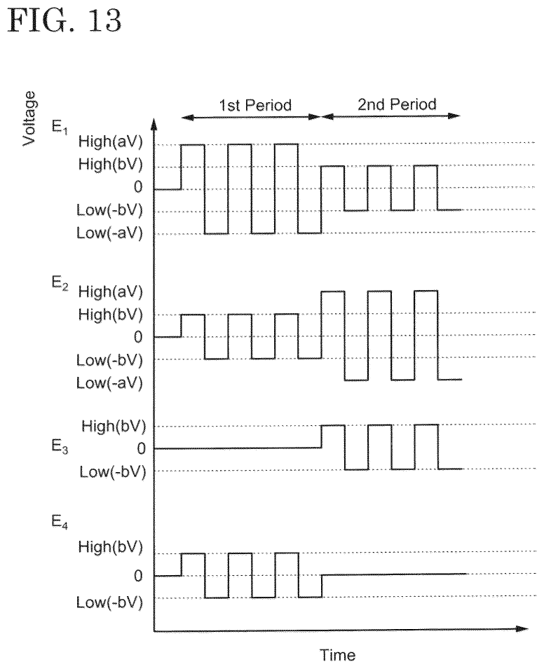

The potentials applied to the lower electrodes 126 can be adjusted accordingly. Thus, for example, the position of the semi-circular arc-shaped refractive index distribution can be shifted in a direction perpendicular to the extending direction of the lower electrodes 126 by supplying potentials to the lower electrodes 126 according to the timing chart shown in FIG. 13. According to the timing chart shown in FIG. 13, the refractive index distribution shown in FIG. 11A is realized in the first period. On the other hand, the potentials applied to the lower electrodes 126 are in the following order in the second period.

E₂>E₁=E₃>E₄

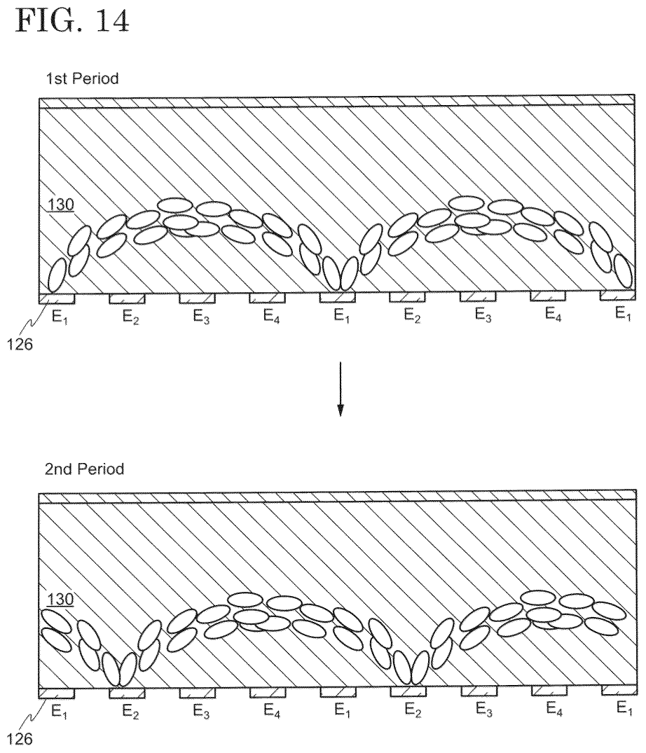

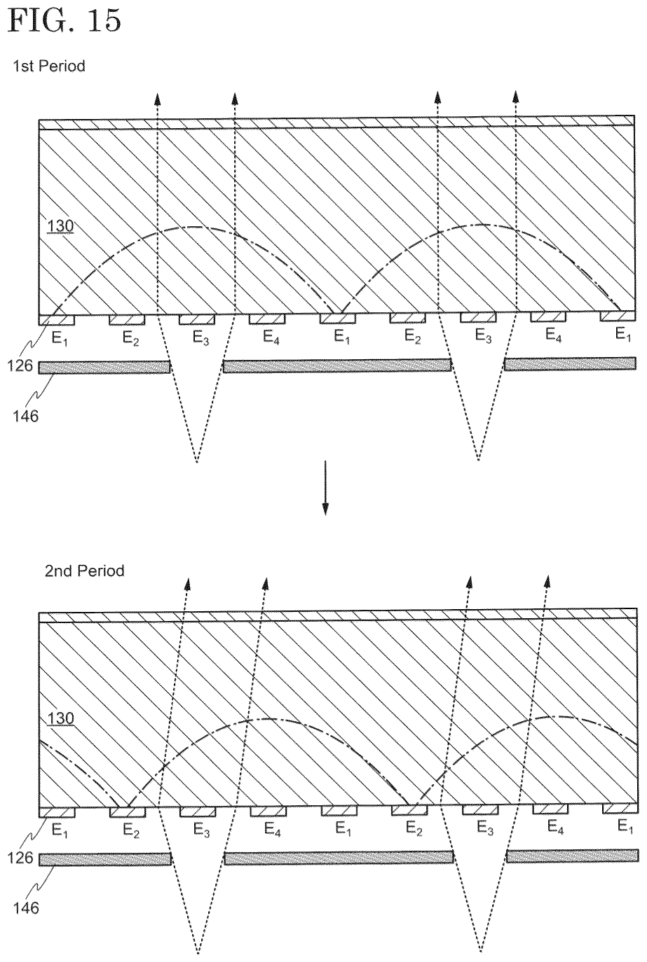

Therefore, when moving from the first period to the second period, the orientation state of the liquid crystal molecules shifts by one pitch of the lower electrodes 126 as shown in FIG. 14. This shift causes a shift in the semi-circular arc-shaped refractive index distribution schematically depicted by the single-dotted lines as shown in FIG. 15, resulting in a change in the refractive pattern of the light passing between the light-shielding films 146 and a change in the travelling direction of the light (see the dotted arrows in FIG. 15). As a result, the illuminated surface A₃ provided in the first period shifts to give the illuminated surface A₄ as schematically shown in FIG. 12B. Although not illustrated, the focal distance and the position of the focal point of the lenticular lens formed by the liquid crystal layer 130 can be changed by changing the pattern and the magnitude of the potentials applied to the lower electrodes 126 as appropriate, so that the travelling direction of the light as well as the shape and size of the illuminated surface can also be controlled as desired.

In summary, the plurality of light-shielding films 146 forms slits fixed over the light source unit 110, and a plurality of stripe-shaped virtual light sources are constructed in the lighting device 160. Lenticular lenses whose focal position, focal distance, or width (length perpendicular to the extending direction of the lower electrodes 126) can be varied are constructed with the liquid crystal cells over these virtual light sources. Thus, the travelling direction of the light passing between the plurality of light-shielding films 146 can be varied, and the shape, the size, and the position of the illuminated surface formed by this light can be controlled as desired.

### 3. Modified Examples

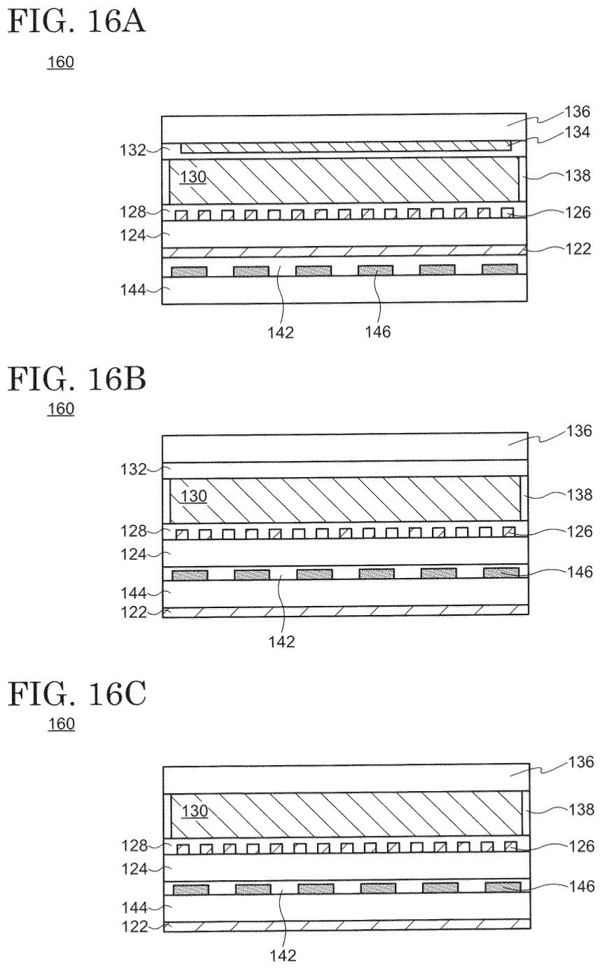

Similar to the First Embodiment, various modifications can be carried out to the structure of the lighting device 160. For example, the lighting device 160 may be configured so that the first polarizing plate 122 is positioned between the light-shielding films 146 and the liquid crystal layer 130 as shown in FIG. 16A. In this case, after bonding the first polarizing plate 122 to the lower surface of the substrate 124, the support substrate 144 over which the light-shielding films 146 are formed may be fixed to the first polarizing plate 122 using the adhesive layer 142 or the like. The use of this configuration suppresses deterioration of the first polarizing plate 122 caused by the light from the light source 114.

Alternatively, the upper electrode 134 may not be provided as shown in FIG. 16B. As described above, the refractive index distribution in the liquid crystal layer 130 is created by the transverse electric field formed by the potentials applied to the lower electrodes 126, and this transverse electric field is mainly formed on the lower electrode 126 side of the liquid crystal layer 130. Therefore, the liquid crystal layer 130 is capable of functioning as a lenticular lens even when the upper electrode 134 for forming the vertical electric field is not provided.

Alternatively, the second orientation film 132 may not be provided as shown in FIG. 16C. Since the refractive index distribution is formed mainly on the lower electrode 126 side of the liquid crystal layer 130, the direction of the refractive index distribution is determined by the orientation direction of the first orientation film 128. In addition, since no polarizing plate is provided over the liquid crystal layer 130, the optical rotation within the liquid crystal layer 130 has no effect on the illuminated surface. Therefore, even without the second orientation film 132, the refractive index distribution can be formed in a certain direction, and the liquid crystal layer 130 can function as a lenticular lens.

As described above, in the lighting devices 100 and 160 according to an embodiment of the present invention, the flat optical element 120 is provided over the light-source device 110. Therefore, the liquid crystal cell is not required to have a three-dimensional shape, and the light distribution can be controlled by the liquid crystal cell composed of the substrate 124 and the counter substrate 136, each of which has a flat top surface and are commonly used in display devices, and the plurality of light-shielding films 146. In addition, an increase in size of the lighting device can be prevented, and the optical element 120 can be also installed on an existing light source. Therefore, the optical element 120 and the lighting device equipped with the optical element 120 can be provided at a low cost.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. A lighting device comprising:
an optical element comprising a liquid crystal cell and a plurality of light-shielding films; and
a light-source device located under the optical element, comprising a housing and a light source in the housing, and configured to apply light onto the optical element,
wherein the liquid crystal cell comprises:
a substrate;
a plurality of lower electrodes located over the substrate and arranged in a stripe form;
a first orientation film over the plurality of lower electrodes;
a liquid crystal layer over the first orientation film;
a second orientation film over the liquid crystal layer;
an upper electrode located over the second orientation film and overlapping the plurality of lower electrodes;
a counter substrate over the upper electrode; and
a first polarizing plate and a second polarizing plate respectively located under the substrate and over the counter substrate,
the plurality of light-shielding films is arranged in a stripe form and overlaps the plurality of lower electrodes, and
an extending direction of the plurality of lower electrodes is parallel to an extending direction of the plurality of light-shielding films.

2. The lighting device according to claim 1,
wherein the plurality of light-shielding films is sandwiched by the counter substrate and the second polarizing plate.

3. The lighting device according to claim 2,
wherein the plurality of light-shielding films is in contact with the counter substrate and the second polarizing plate.

4. The lighting device according to claim 1,
wherein the plurality of light-shielding films is located over the second polarizing plate.

5. The lighting device according to claim 1,
wherein the plurality of light-shielding films is located under the first polarizing plate.

6. The lighting device according to claim 1,
wherein the upper electrode and the plurality of lower electrodes each have a light-transmitting property.

7. The lighting device according to claim 1,
wherein a width of each of the plurality of lower electrodes is smaller than a width of each of the plurality of light-shielding films.

8. The lighting device according to claim 1,
wherein a pitch of the plurality of lower electrodes is smaller than a pitch of the plurality of light-shielding films.

9. The lighting device according to claim 1,
wherein the plurality of light-shielding films contains a metal selected from aluminum, silver, molybdenum, titanium, and tantalum.

10. The lighting device according to claim 1,
wherein the plurality of lower electrodes is configured to be independently supplied with a potential.

11. A lighting device comprising:
an optical element comprising a liquid crystal cell and a plurality of light-shielding films; and
a light-source device located under the optical element, comprising a housing and a light source in the housing, and configured to apply light onto the optical element,
wherein the liquid crystal cell comprises:
a polarizing plate;
a substrate over the polarizing plate;
a plurality of lower electrodes located over the substrate and arranged in a stripe form;
an orientation film over the plurality of lower electrodes;
a liquid crystal layer over the orientation film; and
a counter substrate over the liquid crystal layer,
the plurality of light-shielding films is sandwiched by the polarizing plate and the substrate, and
an extending direction of the plurality of lower electrodes is parallel to an extending direction of the plurality of light-shielding films.

12. The lighting device according to claim 11,
wherein a total number of the polarizing plate is 1.

13. The lighting device according to claim 11,
wherein a thickness of the liquid crystal layer is equal to or greater than 15 μm and equal to or less than 100 μm.

14. The lighting device according to claim 11,
wherein the plurality of lower electrodes each has a light-transmitting property.

15. The lighting device according to claim 11,
wherein a width of each of the plurality of lower electrodes is smaller than a width of each of the plurality of light-shielding films.

16. The lighting device according to claim 11,
wherein a pitch of the plurality of lower electrodes is smaller than a pitch of the plurality of light-shielding films.

17. The lighting device according to claim 11,
wherein the plurality of light-shielding films contains a metal selected from aluminum, silver, molybdenum, titanium, and tantalum.

18. The lighting device according to claim 11,
wherein the plurality of lower electrodes is configured to be independently supplied with a potential.

19. The lighting device according to claim 11,
wherein an extending direction of the plurality of lower electrodes is perpendicular to an orientation direction of the orientation film.

20. The lighting device according to claim 11,
wherein a light-transmission axis of the polarizing plate is parallel to an orientation direction of the orientation film.
